(19) United States
(12) Patent Application Publication
(10) Pub. No.: US 2025/0064040 A1
(43) Pub. Date: Feb. 27, 2025

(54) FISHING LINE THREADING APPARATUS

(71) Applicant: Scott Robert Garrison, Franklin, TN (US)

(72) Inventor: Scott Robert Garrison, Franklin, TN (US)

(21) Appl. No.: 18/809,263

(22) Filed: Aug. 19, 2024

Related U.S. Application Data
(60) Provisional application No. 63/533,568, filed on Aug. 18, 2023.
(60) Provisional application No. 63/541,199, filed on Sep. 28, 2023.

(51) Int. Cl. A01K 97/00; B25F 1/00

(52) U.S. Cl. CPC A01K 97/00; B25F 1/00

(57) ABSTRACT

A fishing line threading apparatus is disclosed herein comprising a main body, a conical cylinder, and a cover. The main body may have a seating chamber defined therein. The conical cylinder may be defined in the main body and operatively connected to the seating chamber. The cover may be slidably coupled to a top portion of the main body and operable to selectively enclose the seating chamber.

### CROSS-REFERENCES TO RELATED APPLICATIONS

This application claims the benefit of U.S. Provisional Patent Application No. 63/533,568, filed Aug. 18, 2023, and U.S. Provisional Patent Application No. 63/541,199, filed Sep. 28, 2023.

A portion of the disclosure of this patent document contains material that is subject to copyright protection. The copyright owner has no objection to the reproduction of the patent document or the patent disclosure, as it appears in the U.S. Patent and Trademark Office (USPTO) patent file or records, but otherwise reserves all copyright rights whatsoever.

### FIELD OF THE DISCLOSURE

The present disclosure relates to a fishing line threading apparatus and methods of use thereof.

### BACKGROUND

Techniques for threading a fishing line through a conventional fishing hook or similar fishing lure or bait are understood to require manual manipulation of the fishing line through an aperture or open-ended eye within the hook's structure to provide a reversible attachment between the line and the hook. These existing techniques present difficulty in threading the line through the hook's aperture or eye due to the relatively small size of each structure and the lack of structural rigidity of the fishing line. Furthermore, conventional fishing hooks include a hook barb. Existing techniques leave the hook barb exposed, thus placing the user in danger of injury from the hook barb.

Current techniques for threading a line through a hook include the use of an assistive device known as a hook threader, which acts to secure the hook in place and guide the fishing line through the eye of the hook. However, known hook threaders may be sized to accept only certain sizes of hooks and provide limited functionality in threading a line through the hook. Accordingly, there is a need to provide a fishing line threading apparatus as an improvement over known hook threaders.

### BRIEF SUMMARY

Embodiments include a novel fishing line threading apparatus and a method of use thereof.

Embodiments of methods and systems further optionally provide a solution to the shortcomings above. In some aspects, the apparatuses described herein relate to a fishing line threading apparatus, including a first side portion with a first coupling protrusion, a second side portion with a second coupling recess, the first side portion and the second side portion matingly engaged with one another, a cover slidably disposed between the first side portion and the second side portion, and a metal line cutter positioned within a slot formed between the first side portion and second side portion.

In some aspects, the first side portion, the second side portion, and the cover may be formed of a plastic material, including polypropylene.

In some aspects, the first side portion and the second side portion together may form a seating chamber for a hook.

In some aspects, the first side portion and the second side portion may each include semi-conical feet.

In some aspects, the first side portion and the second side portion together may form an open-sided aperture extending from a top surface of the first side portion and a top surface of the second side portion to a bottom aperture surface located at an axial location between the top surfaces of the first side portion and the second side portion and a bottom surface of the first side portion and a top surface of the second side portion.

In some aspects, the open-sided aperture include a hook slot extending the length of the open-side aperture, the slot disposed on a side of a working side of the open-sided aperture.

In some aspects, the open-sided aperture varies in diameter and includes a larger diameter at the top surface and a smaller diameter at the bottom aperture surface.

In some aspects, the fishing line threading apparatus includes a line cutter disposed beneath the bottom aperture surface.

In some aspects, the fishing line threading apparatus includes a cover slideably disposed between the first and second side portions and adjacent to the top surfaces of the first and second side portions.

In some aspects, the cover includes one or more semicircular cutouts to engage one or more stopping members of the first and second side portions.

In some aspects, the apparatuses described herein relate to a fishing line threading apparatus comprising a main body having a seating chamber defined therein, a conical cylinder defined in the main body, the conical cylinder being operatively connected to the seating chamber, and a cover slidably coupled to a top portion of the main body, the cover operable to selectively enclose the seating chamber.

In some aspects, the techniques described herein relate to a method of use of the fishing line threading apparatus.

In some aspects, the method of use includes sliding the cover to an open position, placing a hook in a barb-down position within the seating chamber and placing an eye of the hook in the open-sided aperture, and advancing a fishing line through the eye of the hook.

In some aspects, the method of use include sliding the cover to a closed position after placing the hook in the seating chamber.

In some aspects, the method includes ensuring the fishing line is straight and not curved when advancing the fishing line through the eye of the hook.

In some aspects, the method includes curving the fishing line through the slot of the open-sided aperture after the fishing line is advanced through the eye of the hook.

In some aspects, the method includes forming a knot in the fishing line after curving the fishing line through the slot, including bringing a terminal end of the fishing line into proximity with a proximal portion of the fishing line, twisting, and leaving a small loop in the twisted fishing line to make a knot.

In some aspects, the method includes sliding the cover to an open position to remove the hook after the eye of the hook has been threaded with fishing line.

Unless otherwise defined, all technical and scientific terms used herein have the same meaning as commonly understood by one of ordinary skill in the art to which this invention belongs. The present invention may be embodied in other specific forms without departing from the spirit or essential attributes thereof, and it is therefore desired that the present embodiment be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings.

FIG. 1 depicts an exemplary aspect of a conventional fishing hook configured to be used with the fishing line threading apparatus according to the present disclosure.

FIG. 2 depicts an upper perspective view of the fishing line threading apparatus according to the present disclosure.

FIG. 3 depicts an exemplary aspect of the cover of the fishing line threading apparatus according to the present disclosure.

FIG. 4 depicts a side planar view of an exemplary aspect of the fishing line threading apparatus according to the present disclosure.

FIG. 5 depicts a lower perspective view of an exemplary aspect of the fishing line threading apparatus according to the present disclosure.

FIG. 6 depicts an exemplary aspect of operation of the cover of the fishing line threading apparatus according to the present disclosure.

FIG. 7 depicts an exemplary aspect of operation of the cover of the fishing line threading apparatus according to the present disclosure.

FIG. 8 depicts an exemplary aspect of a line cutter according to the present disclosure.

FIG. 9 depicts an upper perspective view of the fishing line threading apparatus according to the present disclosure.

FIGS. 10A and 10B depict a top view of an exemplary aspect of the fishing line threading apparatus according to the present disclosure.

FIG. 11 depicts a side planar view of an exemplary aspect of the fishing line threading apparatus according to the present disclosure.

FIG. 12 depicts an exemplary aspect of a line cutter according to the present disclosure.

FIGS. 13A-13C depict perspective and planer views of the first side portion of the fishing line threading apparatus according to the present disclosure.

FIGS. 14A-14C depict perspective and planer views of the second side portion of the fishing line threading apparatus according to the present disclosure.

FIGS. 15A-15D depict perspective, top planar, side planar, and end planar views, respectively, of an exemplary aspect of the cover of the fishing line threading apparatus 100 according to the present disclosure.

### DETAILED DESCRIPTION

Reference will now be made in detail to embodiments of the present disclosure, one or more drawings of which are set forth herein. Each drawing is provided by way of an explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

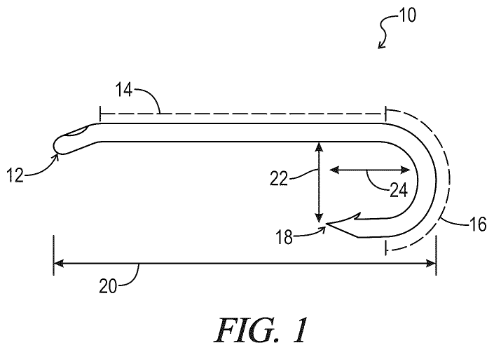

A fishing line threading apparatus of the present invention assists the user with ease and precision. The fishing line threading apparatus may be generally referred to by the number 100. The fishing line threading apparatus 100 may also be referred to herein as the apparatus 100. The fishing line threading apparatus may be configured for use with a conventional fishing hook 10. FIG. 1 depicts an exemplary aspect of a conventional fishing hook 10 configured to be used with the fishing line threading apparatus according to the present disclosure. Conventional fishing hooks 10 may include an eye 12, a shank 14, a bend 16, and a point 18. These structure of the fishing hook 10 may further define certain aspects of a fishing hook, include a total length 20, a gape 22 capable of indicating a space between the point 18 and the shank 14, and a throat 24 capable of indicating a perpendicular distance or space between a point of the bend 16 defining one end of the total length 20 and the point 18. The eye 12 may also be referred to herein as aperture 12. The apparatus 100 may protect users from puncture wounds and prevent injuries, keep fingers away from the point 18, and result in a safer option than threading a fishing hook 10 by hand. The fishing line threading apparatus 100 of the present invention may include a compact size and lightweight design to provide an easy to carry and durable device.

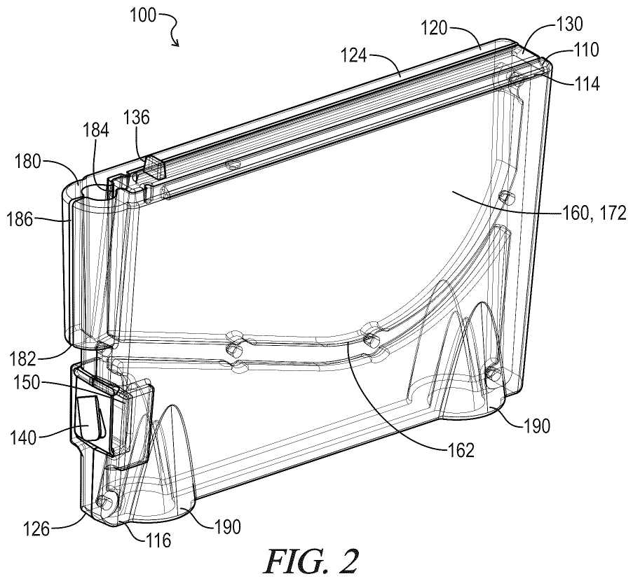

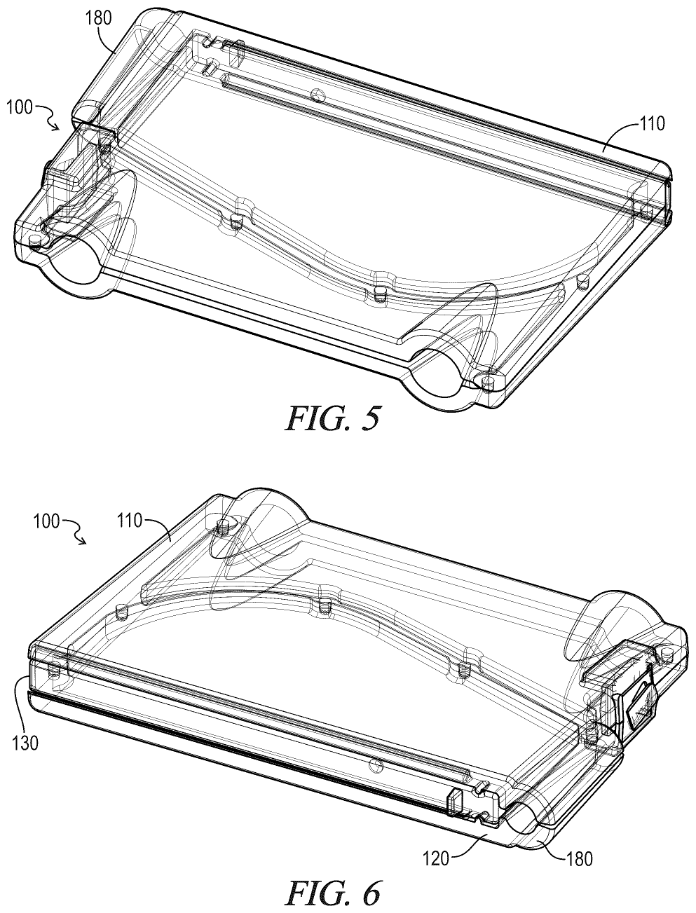

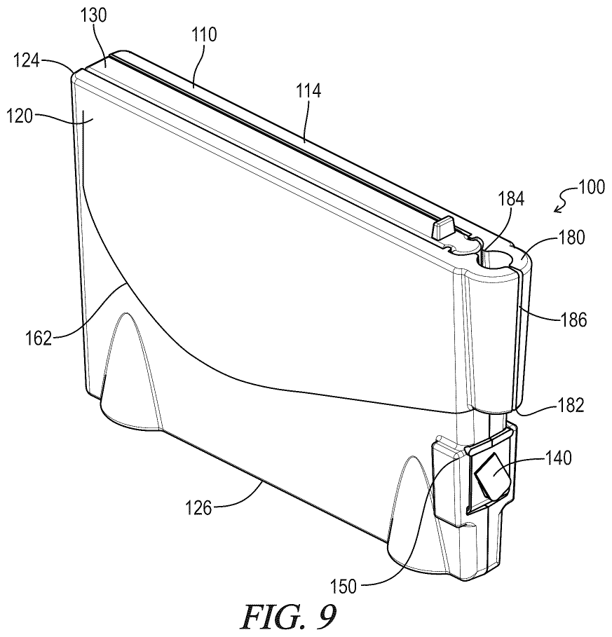

FIG. 2 and FIG. 9 depict an upper perspective view of the fishing line threading apparatus 100 according to the present disclosure. FIG. 5 depicts a lower perspective view of an exemplary aspect of the fishing line threading apparatus 100 according to the present disclosure. The fishing line threading apparatus 100 may comprise a first side portion 110 with a first coupling protrusion, a second side portion 120 with a second coupling recess, the first side portion 110 and the second side portion 120 matingly engaged with one another, a cover 130 slidably disposed between the first side portion 110 and the second side portion 120, and a line cutter 140 positioned within a slot 150 formed between the first side portion 110 and second side portion 120.

At least the first side portion 110 and second side portion 120 may together form a main body of the fishing line threading apparatus 100. The first coupling protrusion of the first side portion 110 may interface with the second coupling recess of the second side portion 120 to couple the first side portion 110 to the second side portion 120.

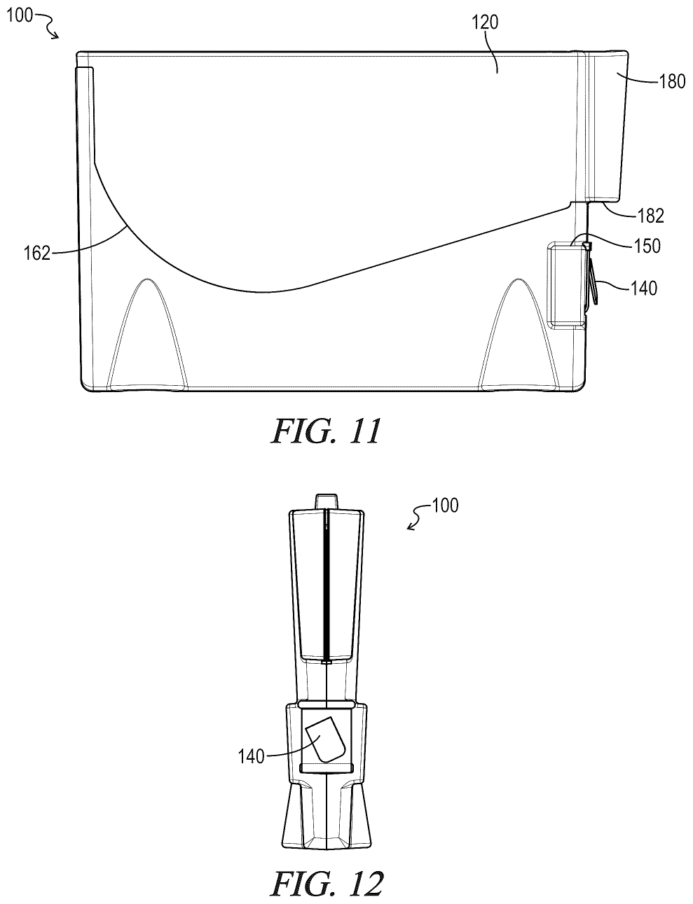

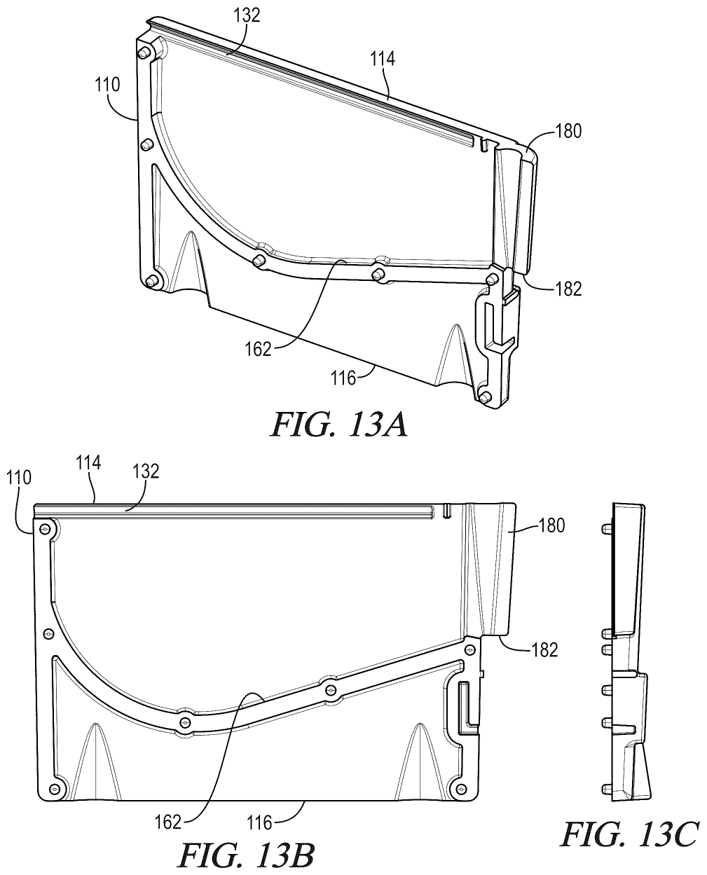

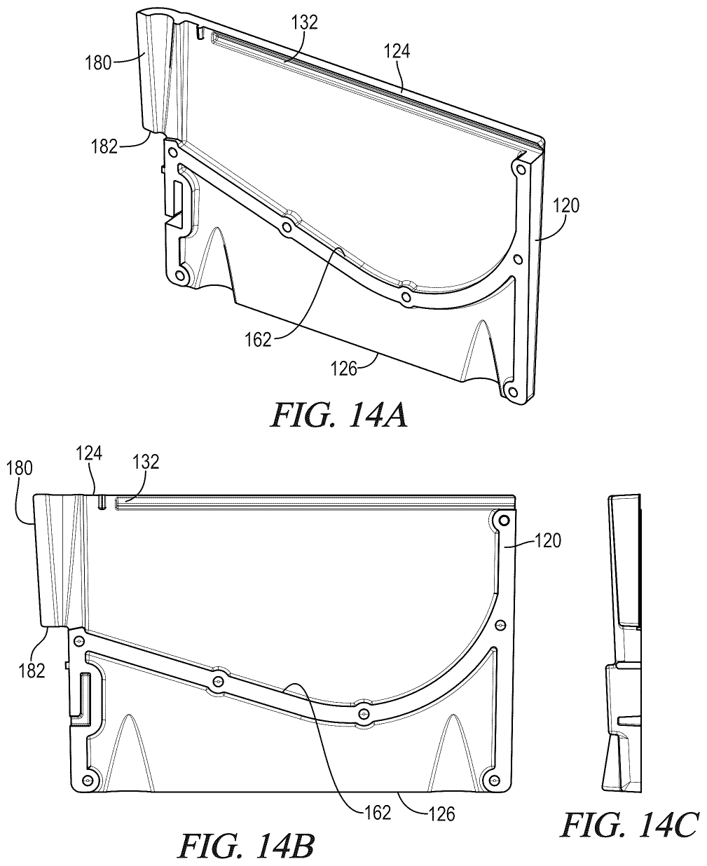

FIG. 4 and FIG. 11 depict a side planar view of an exemplary aspect of the fishing line threading apparatus 100 according to the present disclosure. FIGS. 13A-13C depict perspective and planer views of the first side portion 110 of the fishing line threading apparatus 100 according to the present disclosure. FIGS. 14A-14C depict perspective and planer views of the second side portion 120 of the fishing line threading apparatus 100 according to the present disclosure. The first side portion 110 and the second side portion 120 may together form a seating chamber 172 for a fishing hook 10. The seating chamber 172 may form a portion of an interior 160 of the fishing line threading apparatus 100. The seating chamber 172 may include a backwall 162 defined between the first side portion 110 and second side portion 120. The backwall 162 may be configured to contact the point 18, bend 16, shank 14, or a combination thereof of a fishing hook 10 when it is loaded into the seating chamber 172. The backwall 162 may be non-linear or curved such that the backwall 162 provides sufficient space within the seating chamber 172 for the fishing hook 10.

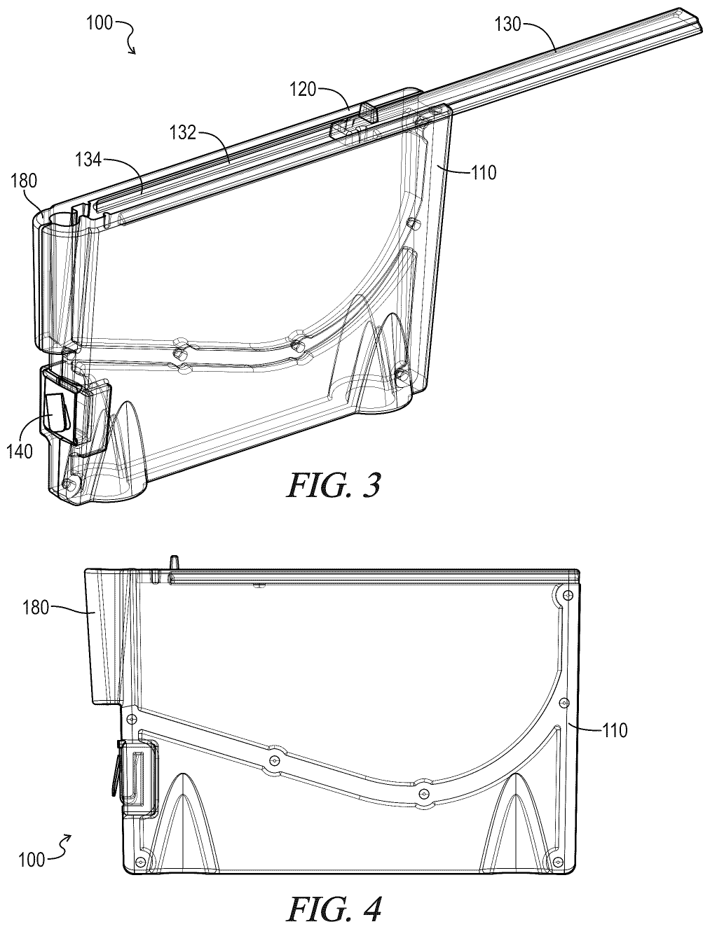

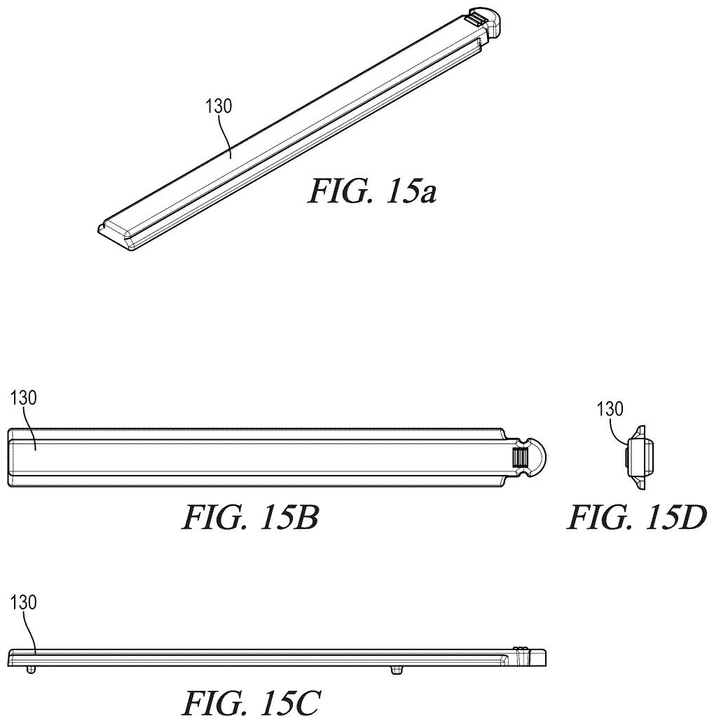

FIG. 3 depicts an exemplary aspect of the cover 130 of the fishing line threading apparatus 100 according to the present disclosure. FIGS. 15A-15D depict perspective, top planar, side planar, and end planar views, respectively, of an exemplary aspect of the cover 130 of the fishing line threading apparatus 100 according to the present disclosure. The cover 130 may be slidably disposed between and adjacent to the first side portion 110 at a top portion 114 and the second side portion 120 at a top portion 124. While the cover 130 is slidably disposed in the illustrated embodiment, it is also within the spirit and scope of the present disclosure for the cover 130 to be otherwise coupled to the first and second side portions 110, 120. For example, the cover 130 may be pivotally connected to the first and second side portions 110, 120.

Each of the top portions 114, 124 of the first and second side portions 110, 120 may include a channel 132. The channel 132 may be configured to receive a portion of the cover 130. Thus, the cover 130 may be configured to slide within the channel 132. The top portions 114, 124 of the first and second side portions 110, 120 may each include a stopping member 134. The stopping members 134 may be configured to engage the cover 130 such that the cover 130 does not slide relative to the first and second side portions 110, 120. The cover 130 and stopping members 134 may be configured such that a predetermined amount of force is required to act on the cover 130 to move the cover 130 relative to the first and second side portions 110, 120. The cover 130 may include one or more semicircular cutouts to engage with the stopping members 134 of the first and second side portions 110, 120.

The cover 130 may include a grip member 136 projecting therefrom. The grip member 136 may be configured such that a user may push on the grip member 136 to manipulate the cover 130 within the channel 132.

The first side portion 110 and the second side portion 120 may together form an open-sided aperture 180 extending from the top portion 114 of the first side portion 110 and the top portion 124 of the second side portion 120 to a bottom aperture surface 182 located at an axial location between the top portions 114, 124 of the first side portion 110 and the second side portion 120 and a bottom portion 116 of the first side portion 110 and a bottom portion 126 of the second side portion 120. The open-sided aperture 180 may vary in diameter and include a larger diameter at the top portions 114, 124 and a smaller diameter at the bottom aperture surface 182. The open-sided aperture 180 may also be referred to herein as a conical cylinder 180. The open-sided aperture 180 may be configure to receive the open-ended eye 12 of a fishing hook 10. The variation in diameter of the open-sided aperture 180 allows the open-sided aperture to receive various sizes of open-ended eyes 12.

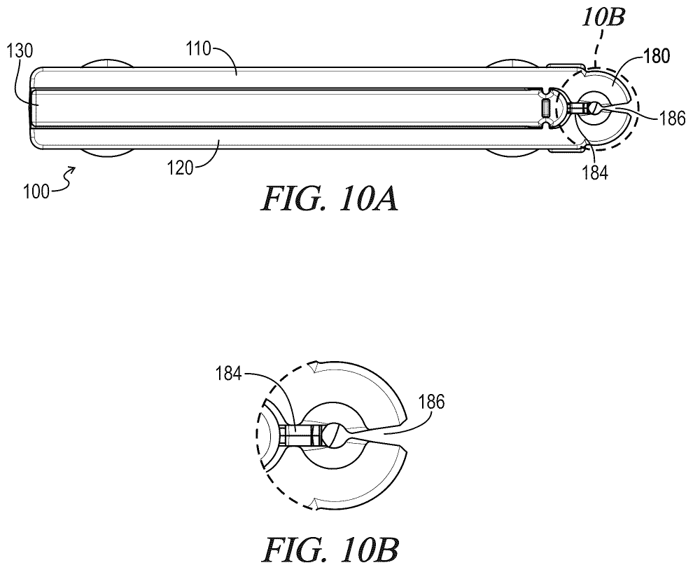

FIGS. 10A and 10B depict a top view of an exemplary aspect of the fishing line threading apparatus 100 according to the present disclosure. The open-sided aperture 180 may include a hook slot 184 extending the length of the open-sided aperture 180, the hook slot 184 disposed on a side of a working side of the open-sided aperture 180. The hook slot 184 may be configured to receive the body 12 of a fishing hook 10 when the open-ended eye 12 of the fishing hook 10 is loaded into the open-sided aperture 180. The open-sided aperture 180 may further include a line slot 186 located on an opposite side of the open-sided aperture 180 from the hook slot 184. The line slot 186 may be configured to receive fishing line therethrough.

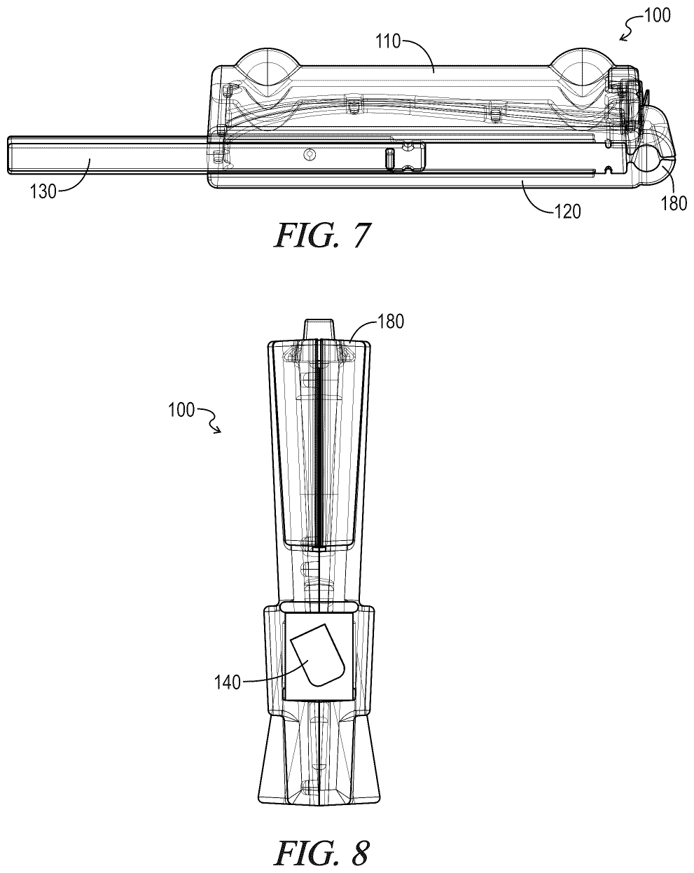

FIG. 6 and FIG. 7 depict an exemplary aspect of operation of the cover 130 of the fishing line threading apparatus 100 according to the present disclosure. The cover 130 may be operable between a closed position and open position. In the closed position, the stopping members 134 of the first and second side portions 110, 120 may engage the cover 130 such that the cover 130 covers an open-end of the seating chamber 172. Thus, in the closed position, a fishing hook 10 may be secured within the seating chamber 172 of the fishing line threading apparatus 100. In the open position, the stopping members 134 of the first and second side portions 110, 120 do not engage the cover 130 and the cover 130 is slid away from the stopping members 134 such that the cover 130 does not completely cover the open-end of the seating chamber 172. Thus, in the open position, a fishing hook 10 may be loaded into or removed from the seating chamber 172.

The fishing line threading apparatus 100 may include one or more semi-conical feet 190. In certain optional embodiments, the first side portion 110 and the second side portion 120 may each include one or more semi-conical feet 190. In the illustrated embodiment, each of the first side portion 110 and second side portion 120 include roughly half of a semi-conical foot 190, and thus the combination of the first side portion 110 and second side portion 120 forms one or more semi-conical feet 190. The one or more semi-conical feet 182 may be operable to support the fishing line threading apparatus 100 from a ground or other surface.

FIG. 8 and FIG. 12 depict an exemplary aspect of a line cutter 140 according to the present disclosure. The fishing line threading apparatus 100 may include a line cutter 140 disposed beneath the bottom aperture surface 182. The line cutter 140 may be operable to cut fishing line, and specifically excess fishing line extending from the open-ended eye 12 of the fishing hook 10. In the illustrated embodiment, the line cutter 140 consists of a raised metal member. However, it is within the spirit and scope of the present disclosure to use other line cutters 140, such as clippers to name one example.

In certain optional embodiments, the first side portion 110, the second side portion 120, and the cover 130 may be formed of a plastic material, such as polypropylene to name one example. In other optional embodiments, the first side portion 110, the second side portion 120, and the cover 130 may be formed of any other suitable material. In some optional embodiments, the first side portion 110, the second side portion 120, and the cover 130 may be formed of a material that is at least partially translucent. Thus, a user may be able to see through the first side portion 110, the second side portion 120, and the cover 130 and into the interior 160 of the fishing line threading apparatus 100. One advantage of this aspect of the disclosure may be that a user is able to monitor the fishing hook 10 as the fishing hook 10 is loaded into the interior 160 of the fishing line threading apparatus 100.

As shown, the fishing line threading apparatus 100 may be operable with fishing hooks 100 of various sizes and shapes. The open-sized aperture 180 may accept various sizes of open-ended eyes 12 and the seating chamber 172 may accept various sizes of fishing hook bodies 12.

The techniques described herein relate to a method of use of the fishing line threading apparatus 100.

The method of use may include providing the fishing line threading apparatus 100. The method of use may further include sliding the cover 130 to the open position such that the open end of the seating chamber 172 is at least partially uncovered.

The method of use may further include placing a fishing hook 10 in a barb-down position within the seating chamber 172 and placing the open-ended eye 12 of the fishing hook 10 in the open-sided aperture 180. The open-ended eye 12 may be slid along the open-sided aperture 180 until the edges of the open-ended eye 12 interface with an internal surface of the open-sided aperture 180.

The method of use may further include advancing a fishing line through the open-ended eye 12 of the fishing hook 10. A user may be assisted in threading the fishing line through the open-ended eye 12 by the open-sided aperture 180. The open-sided aperture 180 may be operable to funnel the fishing line such that it passes through the open-ended eye 12. The fishing line may be advanced through the open-ended eye 12 of the fishing hook 10 at least until the fishing line extends from the bottom aperture surface 182 of the open-sided aperture 180.

The method of use may include sliding the cover 130 to the closed position after placing the fishing hook 10 in the seating chamber 172. Sliding the cover 130 to the closed position may secure the fishing hook 10 inside the seating chamber 172 and protect the user from the hook barb 16.

The method of use may include ensuring the fishing line is straight and not curved when advancing the fishing line through the open-ended eye 12 of the fishing hook 10. This may ensure the fishing line advances through the open-ended eye 12 more easily. However, the open-sided aperture 180 may guide a terminal end of the fishing line through the open-ended eye 12 even if the fishing line is not straight.

The method of use may include curving the fishing line through the line slot 186 of the open-sided aperture 180 after the fishing line is advanced through the open-ended eye 12 of the fishing hook 10. The fishing line may be pulled through the line slot 186 at least until a workable amount of fishing line protrudes from the line slot 186.

The method of use may include forming a knot in the fishing line after curving the fishing line through the line slot 186, including bringing the terminal end of the fishing line into proximity with a proximal portion of the fishing line, twisting, and leaving a small loop in the twisted fishing line to make a knot.

The method of use may include cutting excess fishing line via the line cutter 140. The excess fishing line may be cut while the fishing hook 10 is still secured within the seating chamber 172, or alternatively after the fishing hook has been removed from the seating chamber 172.

The method of use may include sliding the cover 130 to the open position to remove the fishing hook 10 from the seating chamber 172 after the open-ended eye 12 of the fishing hook 10 has been threaded with fishing line.

Optional methods of use of the fishing line threading apparatus may include the following steps:
a. Hold bottom portions 116, 126 of the first and second side portions 110, 120 when operating
b.—Slide cover 130 to the open position
c.—Load the fishing hook 10 in the barb-down position in the seating chamber 172
d.—Place open-ended eye 12 of fishing hook 10 in open-sided aperture 180
e.—Slide cover 130 to the closed position once the fishing hook 10 is loaded into the seating chamber 172
f.—Advance fishing line through the open-sided aperture 180 and open-ended eye 12 of fishing hook 10 while keeping the fishing line straight.
g.—Pull the fishing through the line slot 186 of the open-sided aperture 180.
h.—Form a knot in the fishing line.
i. Cut excess fishing line with lien cutter 140.
j.—Move the cover 130 to the open position and remove fishing hook 10 from the seating chamber 172.

Terms such as “a,” “an,” and “the” are not intended to refer to only a singular entity, but rather include the general class of which a specific example may be used for illustration.

The phrases “in one embodiment,” “in optional embodiment(s),” and “in an exemplary embodiment,” or variations thereof, as used herein does not necessarily refer to the same embodiment, although it may.

As used herein, the phrases “one or more,” “at least one,” “at least one of,” and “one or more of,” or variations thereof, when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. The conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Thus, such conditional language is not generally intended to imply that features, elements, and/or states are in any way required for one or more embodiments, whether these features, elements, and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this disclosure except as set forth in the following claims. Thus, it is seen that the apparatus of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

We claim:

1. A fishing line threading apparatus, comprising:
a first side portion comprising a first coupling protrusion;
a second side portion comprising a second coupling recess;
a cover slidably disposed between a top portion of the first side portion and the second side portion;
a line cutter coupled to the first side portion and the second side portion.

2. The fishing line threading apparatus of claim 1 further comprising novel features of the disclosed invention.

3. The fishing line threading apparatus of claim 1 further comprising nonobvious features of the disclosed invention.

4. The fishing line threading apparatus of claim 1 further comprising all other novel and nonobvious features of the disclosed invention.

5. A fishing line threading apparatus, comprising:
a main body having a seating chamber defined therein;
a conical cylinder defined in the main body, the conical cylinder being operatively connected to the seating chamber; and
a cover slidably coupled to a top portion of the main body, the cover operable to selectively enclose the seating chamber.

6. The fishing line threading apparatus of claim 5 further comprising novel features of the disclosed invention.

7. The fishing line threading apparatus of claim 5 further comprising nonobvious features of the disclosed invention.

8. The fishing line threading apparatus of claim 5 further comprising all other novel and nonobvious features of the disclosed invention.

9. A method of coupling fishing line to a fishing hook, the method comprising:
providing a fishing line threading apparatus having:
a main body having a seating chamber defined therein;
an conical cylinder defined in the main body, the conical cylinder being operatively connected to the seating chamber; and
a cover slidably coupled to a top portion of the main body, the cover operable to selectively enclose the seating chamber;
loading the fishing hook into the seating chamber such that an eye of the fishing hook is located in the conical cylinder;
moving the cover to a closed position wherein the seating chamber is enclosed;
advancing a terminal end of the fishing line through the conical cylinder and eye of the fishing hook; and
forming a knot in the fishing line.

10. The method of coupling fishing line to a fishing hook of claim 9 further comprising novel features of the disclosed invention.

11. The method of coupling fishing line to a fishing hook of claim 9 further comprising nonobvious features of the disclosed invention.

12. The method of coupling fishing line to a fishing hook of claim 9 further comprising all other novel and nonobvious features of the disclosed invention.
